(19) United States
(12) Patent Application Publication
(10) Pub. No.: US 2006/0255187 A1
(43) Pub. Date: Nov. 16, 2006

(54) Shutoff side-outlet valve for incremental fire-hose deployment

(76) Inventor: Adam Rust, Ben Lomond, CA (US)

Correspondence Address: CENTRAL COAST PATENT AGENCY, INC, 3 HANGAR WAY SUITE D, WATSONVILLE, CA, 95076, US

(21) Appl. No.: 11/128,090

(22) Filed: May 11, 2005

(51) Int. Cl. B05B 1/14; B05B 1/30; A62C 2/08

(52) U.S. Cl. 239/548; 239/569

(57) ABSTRACT

A combination through-valve has an inlet interface for engaging a first hose having a first inside diameter, an outlet interface in-line with the inlet interface, for engaging a second hose, a through bore of at least the first diameter from the inlet to the outlet, with a side passage intersecting the through bore and providing a side outlet, and an first externally-operable valve ball having a bore of at least the first diameter disposed in the through bore, operable in a first position to completely block flow through the valve, and in a second position to allow full flow.

### BACKGROUND OF THE INVENTION

The present invention is in the area of firefighting equipment, and pertains more particularly to relatively long distance deployment of fire hoses, and periodic side outlets for use along the deployment range.

Particularly in fighting brush fires and forest fires, which often attain very sizable active burn and recently burned areas, it is common practice for firefighters to deploy long hose runs from a water source to a front-line region. The water source can be any available source, such as a tank and pumping vehicle, or a lake or river with a temporary pump set up. The range of such deployment may be considerable, such as a mile or more.

It is common practice as well for a firefighter to carry one or more hose lengths and a variety of other equipment to make the periodic extensions. For example, in one known situation, all firefighters start with at least two one-hundred-foot sections of single-jacket hose. In the current art, where a new length of hose is added to increase the length of a run, a valved, side-outlet tee is disposed between the two lengths of hose.

A distinct problem in the art is that the valved, side-outlet tees each impose an impediment to flow, and therefore a pressure drop at the junctures of hose sections. Because of this there is a finite pressure drop at each tee in a long run, the drops are additive, and after several such junctions the water pressure may well be too low for effective firefighting operations. Furthermore, because currently-available in-line valves are prohibitively restrictive to flow, and cause significant pressure drops, they are not used in progressive hose runs, and cumbersome clamps are used instead to stop water flow for removing a nozzle and adding a section of hose to a progressive run. Accordingly, what is needed is a combination shut-off and side-outlet tee for hose runs, that has little or no pressure drop effect, and is quicker and simpler to carry and deploy than the conventional method and equipment.

### SUMMARY OF THE INVENTION

In an embodiment of the present invention a combination through-valve is provided, comprising an inlet interface for engaging a first hose having a first inside diameter, an outlet interface in-line with the inlet interface, for engaging a second hose, a through bore of at least the first diameter from the inlet to the outlet, with a side passage intersecting the through bore and providing a side outlet, and an first externally-operable valve ball having a bore of at least the first diameter disposed in the through bore, operable in a first position to completely block flow through the valve, and in a second position to allow full flow.

In one embodiment the valve further comprises a second externally-operable valve in the side passage, for shutting off and initiating flow at the side outlet. In some embodiments the inlet interface is a female threaded interface for engaging a male thread on a hose fitting, and the outlet interface is a male-threaded interface for engaging a female thread on a hose fitting. A valve body for the combination valve may be fashioned of a high-strength, lightweight, heat-resistant material.

In another aspect of the invention a method for providing full flow with minimum pressure drop at an intersection in a hose run is provided, comprising the steps of (a) fashioning a shut-off valve having a through bore at least as large as the inside diameter of hoses in the hose run; and (b) joining two hoses in the run with the combination valve.

In some embodiments there may be a side passage for utility use at the intersection. Also in some embodiments in step (a) an inlet interface is fashioned as a female threaded interface for engaging a male thread on a hose fitting, and an outlet interface is fashioned as a male-threaded interface for engaging a female thread on a hose fitting. Also in some embodiments there may be in step (a) a valve body fashioned of a high-strength, light-weight material.

In another aspect of the invention a method is provided for reducing work load for a firefighter, comprising the steps of (a) fashioning a combination valve having a straight-run shut off and a side outlet as a single unit; and (b) providing a plurality of the combination valves to the firefighter to assemble a hose run. In some cases the straight-run shut-off is a ball valve having a flow diameter at least as large as the inside diameter of hoses in the hose run.

### BRIEF DESCRIPTION OF THE DRAWING FIGURES

FIG. 1 is a schematic of a progressive hose run for fighting a brush fire or forest fire.

FIG. 2 illustrates a combination through valve with a side outlet according to an embodiment of the present invention.

### DESCRIPTION OF THE PREFERRED EMBODIMENTS

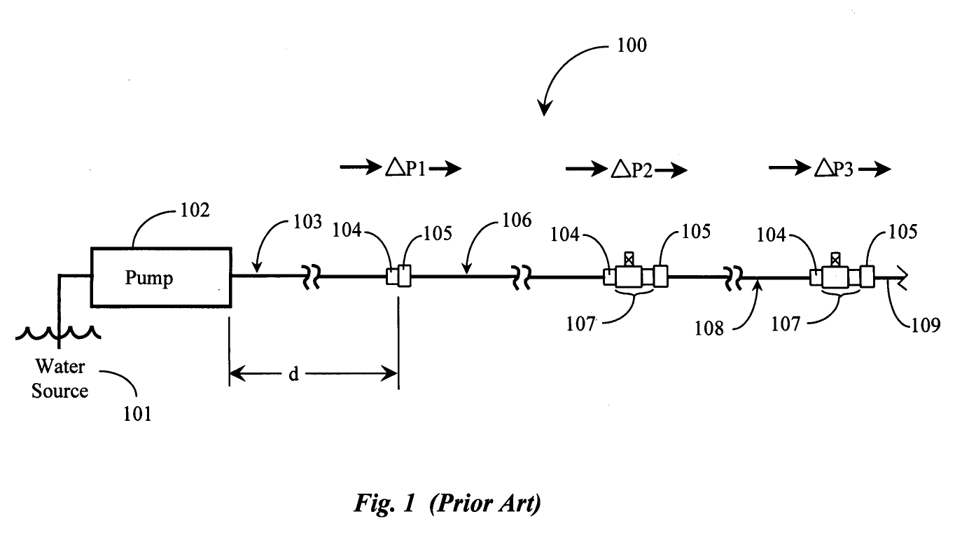

FIG. 1 is a schematic of a progressive hose run 100 for fighting a brush fire or forest fire, meant to be exemplary for many sorts of hose runs deployed by firefighters in their operations. In this illustration a pumping system 102 draws water from a water source 101 and supplies the water under pressure to a first section 103 of run 100. Section 103 is shown broken with a length dimension d, because the dimension may vary significantly, depending on a number of factors, such as standard lengths and sizes of fire hose. A 100 foot length is a common hose length in practice.

The water source 101 may be any water source, and is commonly water from a tank on a pumper engine. Also, first section 103 of fire hose may be somewhat different than later-added sections. Typically, first section 103 is pre-connected to an engine with a nozzle on the end away from the engine, and is stored in a deployable fashion, such as a hose reel. The end 104 away from the engine, where the nozzle is attached, commonly has a male thread, and the nozzle and additional hose lengths have a female-threaded end compatible with the male end of the hose lengths; although these details are not especially pertinent to the present invention.

It is common for each firefighter to carry two one-hundred foot hose lengths, and a variety of other equipment as well. Also, the lengths carried by the firefighters for extending the hose run typically have a pre-assembled, valved side-outlet tee on the male end. The through end of the tee is also male to facilitate attachment of the nozzle, and an additional hose length if necessary.

In operation, when first section 103 is fully deployed, and it is determined a new length is to be added, the nozzle is closed (shut off). A firefighter then applies a hose clamp some short distance (perhaps two or three feet) behind the nozzle, shutting off pressure to the nozzle. The nozzle is then opened relieving pressure in the short section between the clamp and the nozzle, and then the nozzle is removed. Now a firefighter deploys a new hose section 106 to first section 103 by threading female end 105 of the new section 106 to the male end 104 of the first section (where the nozzle was removed).

As described above, it is common for each firefighter to carry two one-hundred foot hose lengths, and a variety of other equipment as well. Also, the lengths carried by the firefighters for extending the hose run typically have a pre-assembled, valved side-outlet tee 107 on the male end. The through end of the tee is also male to facilitate attachment of the nozzle, and an additional hose length if necessary. Therefore, in this example, when second section 106 is added to the run, tee 107 is already in place. At this point the firefighter may assemble the nozzle (not shown in FIG. 1) to the male end of tee 107 at the far end of second section 106, and then release the hose clamp to pressurize the run up to the nozzle.

At this point in the progressive operation there are two sections in the run and one valved side-outlet tee 107. When and if a third run 108 is needed, the process described above is repeated, clamping the hose run behind the nozzle, removing the nozzle, and adding third section 108 also having a side-outlet tee 107 at the male end. The nozzle is then reassembles to the end of tee 107 at the end of section 108. The valved side-outlet tees may be used at any time deemed necessary to assemble a utility hose for such as clean up operations. Typically the straight-run hose sections may be at least 1.5 inch diameter for maximum delivery, and the side outlets may be 0.75 inch or 1 inch diameter.

In the present example there is no side-outlet tee shown between first section 103 and second section 106, but this is simply because there is usually no tee on the end of the first section deployed from the engine. The nozzle may be pre-assembled to this section instead. But this is not limiting, as a firefighter may assemble a tee to the male end 104 of first section 103 after clamping the hose and removing the nozzle, if a tee at this point is deemed needful, and then thread the nozzle to that tee.

As stated above, FIG. 1 illustrates a prior art situation. In this example, there are successive pressure drops □P across the equipment at the end of each hose section, such as through the side-outlet tee. These pressure drops are indicated in FIG. 1 as □P1, □P2, and □P3. Also, there are in the prior-art example no in-line shut-off valves in the hose run. This is true because valves that might be used contribute a significant impediment to flow, and therefore an additional significant pressure drop. So it may be seen that the impediment to flow and pressure drop imposed at each juncture of hose sections is additive (□P1+□P2+□P3), and after a few added sections water pressure is significantly reduced, and at some point effective pressure and flow are reduced to a point that the run is not useful for firefighting.

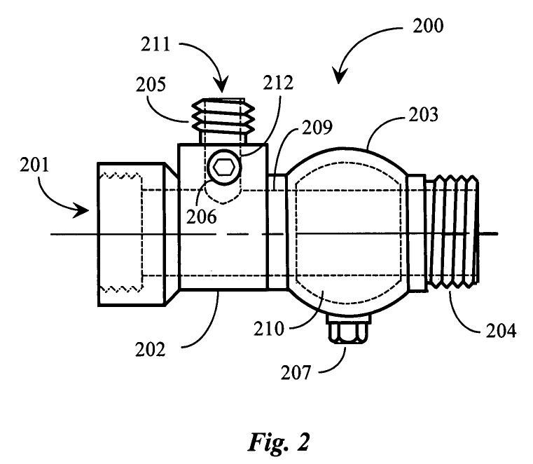

FIG. 2 illustrates a combination through-valve 200 with a side outlet 211 according to an embodiment of the present invention. Combo-valve 200 in this example has a female-threaded inlet 201 for engaging the male end of a hose length in a hose run, and a through-bore 209 which is at least as large in diameter as the inside diameter of hoses in the hose run. A side-outlet bore 212 intersects with through-bore 209 to provide an outlet for a utility hose at each of the intersections in a hose run where a valve 200 may be deployed. The diameter of bore 212 is typically less than that of through-bore 209, but this is not a problem, as the diameter is sufficient for the purposes of the outlet. The side outlet in this embodiment has a shut-off ball valve operated by post 206 to stop and start flow at the side outlet as needed. In this embodiment this valve portion is fashioned as a conventional ninety-degree operable ball valve as known in the art. It is noted, however, that the nature of this side-outlet valve as a ball valve is simply a preference, and is not limiting in the invention. The side outlet valve may be implemented in other ways than as a ball valve.

The full-diameter through feature of the combo valve is assured by an expanded portion 203 housing an oversize valve ball 210, which provides a passage through the ball of at least the same diameter as the passage 209 through the combo valve. Ball 210 is operated by post 207 in this embodiment.

At the end opposite inlet 201 a male-threaded outlet 204 provides for connection to a next hose in a progressive hose run. The inside details of the valve balls and the seats for the balls, and also for the posts to operate the valve balls are not limiting in the invention. These details are according to known techniques, except for the unique features of the full-diameter through bore and the combination of the side outlet with the through-valve shut-off.

The intent in FIG. 2 is that flow is left to right, having therefore a female-threaded inlet and a male threaded outlet. This is not, however, limiting in the invention, because the valve may, for example, be still be assembled if the hose sections end in female threaded junctures, with flow from right to left in FIG. 2. In some cases as well, the positions of ball valve 210 and side outlet 211 may be reversed.

The skilled artisan will recognize that there may be many alterations made to the embodiment described without departing from the spirit and scope of the invention. For example, there are many materials that may be used in construction of the parts for the combo-valve. Metals and plastics may be used, for example, and high-strength polymer and composite materials using, for example, carbon fibers. In a preferred embodiment the materials are selected for high strength-to-weight ratio, to provide lower-weight components for the firemen that must carry several of the combo-valves in practice, and materials with heat resistance are also preferable.

It will be clear to the skilled artisan as well that the invention is not limited by the nature of the interfaces for incoming and outgoing hoses. These can be to any necessary standard. Further, the sizes may vary in different embodiments, to accommodate hoses of different sizes and types.

The single combo-valve according to embodiments of the present invention, even using conventional materials, is already lighter in weight than the equivalent separate components that must be assembled to provide similar function, and provides are significantly reduced impediment to flow. The present invention, because of these and other reasons, is to be limited only by the scope of the claims that follow:

I claim:

1. A combination through-valve, comprising:
an inlet interface for engaging a first hose having a first inside diameter;
an outlet interface in-line with the inlet interface, for engaging a second hose;
a through bore of at least the first diameter from the inlet to the outlet, with a side passage intersecting the through bore and providing a side outlet; and
a first externally-operable valve ball having a bore of at least the first diameter disposed in the through bore, operable in a first position to completely block flow through the valve, and in a second position to allow full flow.

2. The combination valve of claim 1 further comprising a second externally-operable valve in the side passage, for shutting off and initiating flow at the side outlet.

3. The combination valve of claim 1 wherein the inlet interface is a female threaded interface for engaging a male thread on a hose fitting, and the outlet interface is a male-threaded interface for engaging a female thread on a hose fitting.

4. The combination valve of claim 1 with a valve body fashioned of a high-strength, light-weight, heat-resistant material.

5. A method for providing full flow with minimum pressure drop at an intersection in a hose run, comprising the steps of:
(a) fashioning a shut-off valve having a through bore at least as large as the inside diameter of hoses in the hose run; and
(b) joining hoses in the run with the combination valve.

6. The method of claim 5 further comprising a side passage for utility use at the intersection.

7. The method of claim 5 wherein in step (a) an inlet interface is fashioned as a female threaded interface for engaging a male thread on a hose fitting, and an outlet interface is fashioned as a male-threaded interface for engaging a female thread on a hose fitting.

8. The combination valve of claim 5 wherein in step (a) a valve body for the shut-off valve is fashioned of a high-strength, light-weight material.

9. A method for reducing work load for a firefighter, comprising the steps of:
(a) fashioning a combination valve having a straight-run shut off and a side outlet as a single unit; and
(b) providing a plurality of the combination valves to the firefighter to assemble a hose run.

10. The method of claim 9 wherein in step (a) the straight-run shut-off is a ball valve having a flow diameter at least as large as the inside diameter of hoses in the hose run.
